(19) United States
(12) Patent Application Publication
(10) Pub. No.: US 2018/0249100 A1
(43) Pub. Date: Aug. 30, 2018

(54) High resolution multi-aperture imaging system

(71) Applicants: Kyle D. Watson, Carlsbad, CA (US); Kyle Robert Drexler, San Diego, CA (US); Brett A. Spivey, Carlsbad, CA (US)

(72) Inventors: Kyle D. Watson, Carlsbad, CA (US); Kyle Robert Drexler, San Diego, CA (US); Brett A. Spivey, Carlsbad, CA (US)

(73) Assignee: Trex Enterprises Corporation, San Diego, CA (US)

(21) Appl. No.: 15/330,487

(22) Filed: Sep. 26, 2016

(51) Int. Cl. H04N 5/351; H04N 5/232; H04N 7/18; H04N 5/213; H04N 5/225; B64D 47/08; B64C 39/02

(52) U.S. Cl. CPC H04N 5/351; H04N 5/23212; H04N 7/185; B64C 2201/127; H04N 5/2254; B64D 47/08; B64C 39/024; H04N 5/213

(57) ABSTRACT

An aircraft imaging system for night and day imaging at ranges up to and in excess of 100 km with resolution far exceeding the diffraction limit. In a preferred embodiment two separate techniques are utilized on an aircraft to provide for night and day surveillance. The first technique is to provide a multi-aperture active imaging system for daylight imaging. The second technique is to provide a multi-aperture passive imaging system for day and night imaging. In preferred embodiments both techniques are utilized on the aircraft.

### FEDERALLY SUPPORTED RESEARCH

The present invention was made in the course of work performed under Contracts No. FA8650-14-M-1792 with the Defense Advanced Research Projects Agency and the United States Air Force and the United States Government has rights in the invention.

The present invention relates to imaging systems and in particular to high resolution imaging systems.

### BACKGROUND OF THE INVENTION

The resolution of an optical imaging system—a microscope, telescope, or camera—can be limited by factors such as imperfections in the lenses or misalignment. However, in the past there has been a fundamental belief that there is a maximum to the resolution of any optical system which is due to diffraction. An optical system with the ability to produce images with angular resolution as good as the instrument's theoretical limit is said to be diffraction limited. The resolution of a given instrument is proportional to the size of its objective, and inversely proportional to the wavelength of the light being observed.

### Fourier Telescopy

Fourier telescopy is an imaging technique that uses multiple beams from spatially separated transmitters to illuminate a distant object. This imaging technique has been studied extensively for use in imaging deep space objects. In prior art system designs, for example, three beams would be transmitted simultaneously in pulses to image a geosynchronous object. It would take many hours to transmit the tens of thousands of pulses needed to construct all of the spatial frequencies needed to form an image of the object. Because the position and orientation of the object would remain essentially constant, this approach seemed feasible. Three illuminating apertures were used in order to eliminate the degrading atmospheric phase aberrations using the well-known technique of phase closure, and then the closure phases used to reconstruct the illuminated target image. Previous experiments in both the lab and field have verified that this implementation of the Fourier Telescopy technique to imaging geostationary targets is both viable and robust.

U.S. Pat. No. 8,542,347, Super Resolution Telescope, assigned to Applicants employer, describes a technique to increase the spatial resolution of a telescope by factors of two or more compared to the diffraction limit. The teachings of this patent are incorporated herein by reference. The technique uses three laser beams at the periphery of the telescope aperture to illuminate a distant target. The beams are shifted slightly in frequency and as a result produce interference patterns on the target. Upon reflection of the interference pattern off the target, the pattern is modified by the target profile in two dimensions. An image of the reflected pattern is produced by the same telescope and is analyzed and compared with an ideal projected pattern. Target properties are extracted from the collected image data and processed to form an image of the target.

U.S. Pat. No. 8,058,598, also assigned to Applicants employer, describes a Fourier telescope imaging system for collecting images of low earth orbit satellites. It utilizes a large array of laser transmitters each transmitting at frequencies slightly shifted relative to the other transmitters for illuminating the satellite to produce beat frequencies on the target satellite and a large number of light bucket-type sensors to collect light reflected from the target satellite. The positions of the laser transmitters and frequencies are recorded and stored along with the light intensities collected in the light buckets. The stored information provides a large matrix of data which is processed by one or more computers utilizing special algorithms including Fourier transforms designed to produce images of the satellite.

Performing tactical identification and intelligence surveillance and reconnaissance missions at longer standoff ranges from an unmanned aircraft is a challenging task. Traditionally high resolution imaging systems are limited by the sensor clear aperture of ball turrets. However, simply increasing the aperture diameter, if it were possible, would not alone be sufficient due to limitations from the atmospheric coherence length which places an upper limit on the effective clear aperture. This means that the two largest constraints of the resolution in an imaging system are turbulence and receiver diameter.

What is needed is techniques and equipment for aircraft surveillance at distances in the range of 5 km to 100 km or greater.

### SUMMARY OF THE INVENTION

The present invention provides an aircraft imaging system for night and day imaging at ranges up to and in excess of 100 km with resolution far exceeding the diffraction limit. In a preferred embodiment two separate techniques are utilized to provide for night and day surveillance. The first technique is to provide a multi—aperture active imaging system for day and night imaging. The second technique is to provide a multi-aperture passive imaging system for daylight imaging. Preferable, both systems are provided on the aircraft which could be a un-maned aircraft or a piloted aircraft. Both systems are conformable and in preferred embodiments provide resolutions equivalent of better than clear 73 cm diameter telescope by way of aperture synthesis resolution gain and fringe imaging telescopy.

Embodiments of this imaging system has advantages over the current state-of-the-art as listed below:
Equivalent resolution of a 73 cm clear aperture in a conformal configuration both for active and passive only imaging techniques by way of aperture synthesis resolution gain and fringe imaging telescopy
Images through atmospheric turbulence correcting for atmospheric blurring at ranges >100 km
Active and passive techniques achieve night and day imaging capabilities
Conformal design allows for placing on size, weight and power (SWaP) limited UAVs or similar aircraft

Imaging resolution is normally limited by aperture size (˜λ/D) and/or atmospheric turbulence when D>r₀, where r₀ is the Fried parameter. For imaging systems designed for collecting images from ranges in excess of 100 km, atmospheric turbulence will often need to be addressed. Applicants techniques overcomes both of these limitations by utilizing a multi-aperture system in conjunction with previously developed active and passive imaging programs to arrive at a hybrid conformal optical system allowing the overall system to be relatively flat and lightweight; thus allowing operation on a UAV or on a piloted having limited available space.

### Active System

The active systems based on a Fringe Imaging Telescopy (FIT) approach which was developed for partially coherent active imaging of a target permitting resolution beyond the diffraction limit. These techniques have been demonstrated by generating high resolution images of targets of interest at long stand-off ranges. Demonstrated results of both simulation and experimental validation have shown that smaller optical apertures can be used to acquire images that have the equivalent resolution as systems two to three times a single circular aperture.

The present multi-aperture imaging capability provides a significant improvement over conventional imaging methods due to the conformal nature of the arrays, smaller volumes and greater cross sections.

### Passive System

The passive embodiments of is based on a vision system Applicants refer to as their Super Resolution Vision System (SRVS). A key component of the SRVS is an algorithm they call their block matching algorithm (BMA), used to compensate for the effect of turbulence. The BMA is used to sense turbulence induced localized shifts (warping) and perform a correction (de-warping) of the image. The algorithm has been shown to provide the information necessary to reconstruct imagery correcting for space varying tilt and low order wave front aberrations. The BMA accomplishes this by subdividing a target scene into equally partitioned overlapping blocks and estimating the local block shifts, or local tilts, by comparing incoming frames with a continuously updated reference image. The comparison is performed by maximizing a spatial correlation between image blocks within a localized search window.

Applicants' BMA algorithm calculates an Image Quality Metric (IQM) for each incoming frame and sub-portions within each frame and ranks the regions according to their IQM value. If the detector frame rate is selected to exceed the output rate to the observer, then data frames with an IQM below a determined threshold are rejected, whereas the data frames with a high IQM are summed to reduce atmospheric effects and increase the signal-to-noise ratio (SNR). Likewise, regions with a high IQM are selected to be stitched into a composite high resolution image.

### PREFERRED EMBODIMENT

Special preferred embodiments include high resolution multi-aperture aircraft imaging systems for imaging targets at ranges in excess of 50 km comprising: 1) at least three apertures for collecting light reflected from the target, an optical sensor having a pixel array for converting light intensity into electrical signals at each pixel of the pixel array, 2) focusing components for focusing the light from the at least three apertures onto three separate non-overlapping positions of the optical array, 3) an optical beat extraction components for extracting beat signals from the electrical signals, and 4) computer processor components programmed with at least one algorithm to process the beat signals to: i) correct for phase distortion in each of the at least three signals, ii) correct for jitter in each of the at least three signals, iii) de-convolve the jitter corrected signal, and iv) re-combine the beat signal data from the at least three separate apertures in order to produce an image of the target.

These systems may be adapted to utilize a homodyne aperture or a heterodyne aperture reconstruction technique. Beat signals may be spatially separated beat terms. A phase tilt solver is utilized to correct the phase distortion. Jitter may be corrected with a jitter correction algorithm to produce a jitter corrected signal. An estimated power and noise spectrum may be utilized to de-convolve the jitter corrected signal. A block matching algorithm may be utilized to sense turbulence induced localized shifts in images and to perform correction of the images.

### BRIEF DESCRIPTION OF THE DRAWINGS

FIG. 1 shows a Global Hawk fitted with a three aperture active imaging system of an embodiment of the present invention.

FIG. 2 shows the dimensions of the apertures of the three receive and the three transmit apertures.

FIG. 3 is a chart showing differences in the homodyne and heterodyne embodiments of the present invention.

FIG. 4 is a chart showing transmission of visible light signals at ranges up to 200 km for bandwidths of 10 nm, 50 nm a\nd 150 nm.

FIG. 5 shows a typical three aperture configuration for preferred embodiments of the present invention.

FIG. 6 shows graphically in the Fourier domain a technique for finding phases in a preferred fringe imaging process.

FIG. 7 demonstrates a homodyne technique for extracting the modulation transfer function as compared to determining the MTF with a conventional telescope.

FIGS. 8A and 8B compares MTF responses in the cases of (1) single aperture, (2) 3 aperture, (3) 6 aperture and (4) active synthetic three aperture.

FIG. 9 shows a multi-aperture telescope design utilizing Risley prisimes for limiting spectral bandwidth.

FIG. 10 shows a concept for separating and collimating wave fronts in a preliminary hardware validation.

FIGS. 11 and 12 illustrate an optical race tracing in Zemax for a three aperture design.

FIG. 13 illustrates a ray trace for a six aperture design.

### DETAILED DESCRIPTION OF PREFERRED EMBODIMENTS

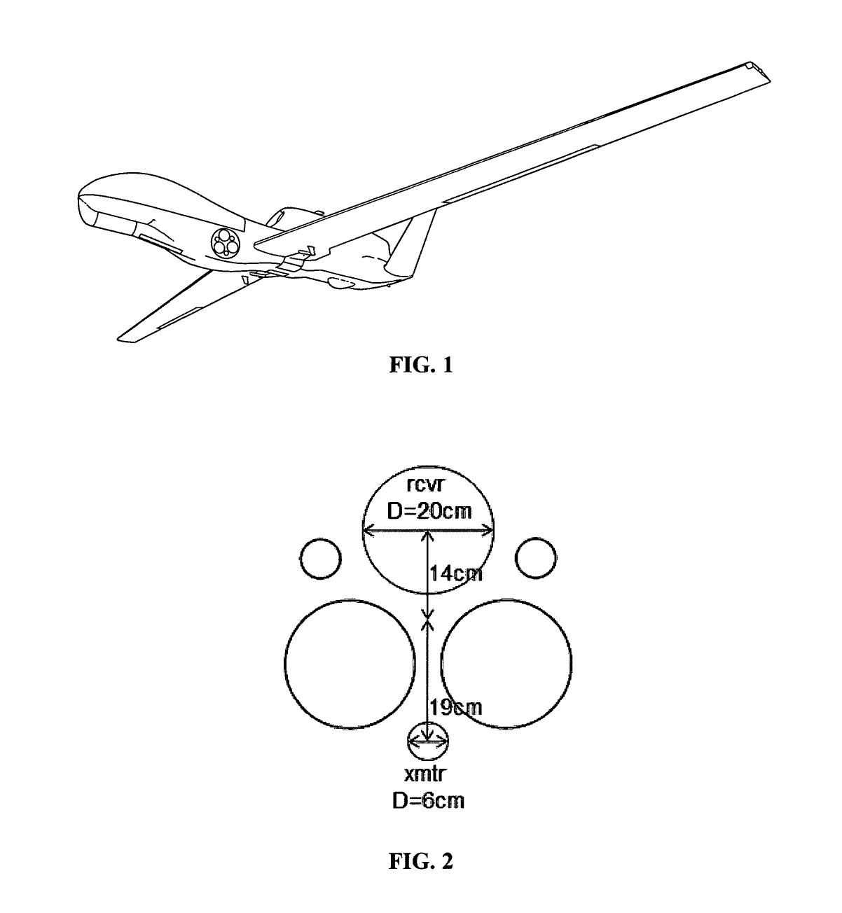

FIG. 1 shows conceptually how embodiments of the present invention fit into a Global Hawk class unmanned UAV. A key aspect for this system is the conformal nature of the optical system. Using multiple apertures embodiments can be packaged into a relatively small volumes as compared to prior art systems. The insert in FIG. 1 shows a three aperture active imaging system positioned on the body of the Gloobal Hawk in front of one of the wings. FIG. 2 shows the dimensions of the three transmitters (xmtr) and the three recievers (rcvr).

Imaging examples were prepared with simulations utilizing Mat Lab technology as modified by Applicants to import physical computer models of the targets with light propagating to and reflecting from the target models. The accuracy of the simulations were confirmed by actual imaging hardware in conjunction with phase solving techniques developed by Applicants as explained later in the section entitled “Preliminary Passive Hardware Validation”. Some advantages of these embodiments are:
1. Multi-aperture systems can provide high resolution imaging at long stand-off ranges during stealth operation
2. Conformal optical system can be used when SWaP is a limitation
3. Combination of active and passive imaging allows for night and day imaging capability

Embodiments create a long distance high-resolution imaging system with a smaller aperture footprint. Embodiments include a three-aperture array in conjunction with fringe imaging, and the homodyne system that could utilize a three or six aperture array.

The basis of the present invention lies in the increased sensor resolution that is realized through the implementation of a synthetic aperture which is generated by combining multiple smaller apertures together in conjunction with atmospheric turbulence compensation. Further increases to the effective receiver diameter are realized by employing shifted laser illumination sources to increase the spatial frequency information of the target.

The process of aperture synthesis minimizes size weight and power by enabling a larger monolithic aperture to be replaced with a number of smaller sub-apertures, with the reduction in volume approaching the ratio of the sub-aperture diameter to the system aperture diameter. The digital phasing of the sub-apertures to create the unified synthetic aperture is compatible with previously demonstrated atmospheric turbulence compensation techniques. Additionally, synthetic aperture techniques that are compatible with both active and passive illumination are highly beneficial since active illumination provides higher resolution by further increasing the size of a synthesized aperture through the use of multiple transmitters, while passive illumination may be used to view a larger area of interest at longer standoff ranges.

Applicants have made significant advances, beyond the current state of the art, in aperture synthesis. These advances include:
A conformal synthetic aperture system compatible with both active and passive techniques
Efficient in terms of required signal illumination and exposure requirements approaching those of an ideal aperture equal in size to the system's synthesized aperture.
Size, weight and power compatible with a pod or electro-optic turret.
Operable in atmospheric profiles consistent with Hufnagel-Valley 5/7 standard
Standoff ranges greater than 100 km

An ideal hybrid imaging solution can be broken down into three main techniques. The first is the basic aperture synthesis technique that allows a larger aperture to be implemented without significantly increasing the required volume. This is done by employing multiple size weight and power efficient conformal receivers that are phased together. The second technique is the addition of the fringe imaging technique which permits an even larger aperture to be synthetically created without increasing the physical receiver diameter, and the third and final technique is atmospheric warping compensation which permits an increased in the effective receiver size without limitations due to atmospheric turbulence. The result is a hybrid imaging system compatible with partially coherent and passive illumination which achieves increased resolution with reduced sensor volume and speckle noise.

### Atmospheric Compensation Techniques

There are two different atmospheric compensation techniques used in reconstructing the final image after digitally synthesizing the full aperture from the sub-apertures. One is passive and the other is active as described above. Both passive and active embodiments utilize the aperture synthesis system of creating a larger array through multiple sub-apertures in conjunction with turbulence compensation, but only the active system would utilize the fringe imaging technology of increasing the effective receiver diameter though structured illumination. Both embodiments are designed to achieve a resolution comparable to a 73-cm clear aperture.

### Active Illumination

FIG. 2 shows a sub-aperture array in a triangular pattern in conjunction with the fringe imaging technique. The combination of this array with fringe imaging produces better resolution than the passive only case with a smaller aperture footprint. This system uses Geiger mode avalanche photodiodes which permits the collection of range gated data which can be used in for atmospheric compensation.

### Passive Imaging Synthetic System

Embodiments of the passive case uses a three or six sub-aperture array arranged in an array pattern to maximize the received resolution while maintaining the necessary sampling at lower frequencies. The passive case is implemented using the homodyne technique. The main advantage of this system is that the technology to implement it is at a higher readiness level and does not require a laser to operate. One obvious downside is that it is unable to operate at night.

### Homodyne Vs Heterodyne Trade Study

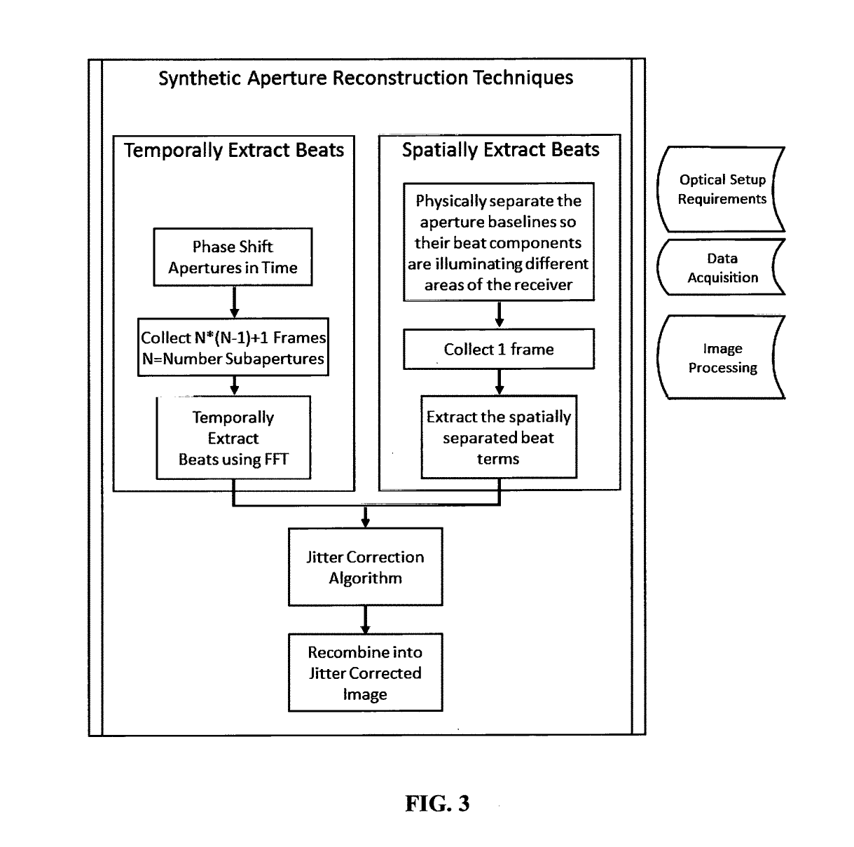

Multi-aperture imaging systems require coherently combining the signal from the individual sub-apertures. There are two main ways of accomplishing this, homodyne and heterodyne. In order to accurately phase together the sub-apertures the phase piston error must be measured and corrected. In order to do this, the interference patterns between each pair of sub-apertures must be uniquely measured. The homodyne technique measures these interferences by way of uniquely separate the light rays so they can isolate the spatial frequencies in each single frame of data. The heterodyne technique uniquely encodes the interferences by way of temporal differential phase piston sweeps. The main difference between these techniques is that the homodyne technique requires more pixels and the heterodyne technique requires faster pixels. A block diagram of the data collection for these two techniques is shown in FIG. 3.

Due to the need for fast pixels, the heterodyne technique a Geiger mode avalanche photodiode array is preferred, which also permits active laser photons to be range gated allowing the image to be broken into range slices. This range slice information is used in a de-warping algorithm which results in a cleaner reconstruction in strong turbulence regimes.

### Trade Study Details

### Sensor Trades

A key difference between the passive homodyne and active heterodyne systems are the constraints placed on hardware, in particular the sensor array. The active heterodyne technique requires seven frames of data (with three sub-apertures) to process and reconstruct an image, which means that for moving targets a fast frame rate detector is necessary to freeze the target motion. Unfortunately, this fast frame rate requirement limits the choice of detector arrays. This can be a problem for very fast frame rates since faster arrays are generally smaller and this reduced sensor area can lead to a smaller field of view.

The passive homodyne technique on the other hand requires a larger number of pixels to achieve the same field of view due to the spatial encoding required. However, since the data is acquired in one frame a lower frame rate detector can be used. The reduced frame rate makes available a broader selection of sensors since there are many choices that have both a large number of pixels and low electron noise. These detectors will generally have a higher technology readiness level.

### System Modules

Another important aspect is the fact that in the homodyne technique the sensor is decoupled from the sub-aperture tracking and pointing system, whereas the heterodyne technique requires the aperture phase shifters to be synchronized with the sensor. This decoupling is possible because no additional aperture phase shifting is required in the homodyne system which relies only on a single frame, meaning that there could be a dedicated computer accepting the data, that doesn't communicate to a pointing system. This makes the entire system more modular. A summary of the trade-offs between the two design are shown in Table 1

TABLE 1
Homodyne & Heterodyne Trade Study

| | Homodyne | Comment | Heterodyne | Comment |
|---|---|---|---|---|
| Frames of data required to | 1 | Combined apertures | N(N − 1) + 1 | Combined apertures |
| process an image | | are separated spatially | N = #SubApertures | are separated |
| | | | | temporally |
| Method of baseline | Spatial frequency | Spatial beat term | Temporal phase | Temporal beat term |
| separation | isolation | separation using | shift frequency | separation using |
| | | physical optical | isolation | multiple frames and |
| | | system | | phase shifter |
| Detector type | Large array | Inherent High TRL | Geiger mode APD | Geiger for high frame |
| | | | | rate |
| Processing time to generate | readout time of 1 array + | Regardless of the | readout time of # | The number of frames |
| a phased aperture | Beat term extraction | number of sub- | smaller arrays + | necessary will be |
| | through shifting | apertures used, there | FFT for beat | either 7 or 31 |
| | | will only be one frame | extraction | depending on the |
| | | necessary | | number of apertures (3 |
| | | | | vs 6) |
| Number of pixels for | 3 Apertures: 384 × 384 | Larger array needed | 128 × 128 | Limited by fast |
| comparable pixel density of | 6 Apertures: 806 × 806 | for spatial term | | readout |
| 128 | | separation | | |
| Optical complexity | Med | Requires beat term | Med | Requires phase shifter |
| differences | | separation through | | |
| | | optics | | |
| Electronics complexity | Low | Mostly associated with | Low | Mostly associated with |
| | | pixel readout | | pixel readout |
| Overall complexity of | Med | Deemed more | Med | |
| system | | complex due to optics | | |
| | | separation | | |
| System hardware maturity | High TRL | Hardware exists | Lower TRL | Hardware exists |
| level | | | hardware | |

### Link Budget

The following section describes the link budget calculations used in assessing performance of the present invention. There are separate atmospheric considerations that are necessary to account for, transmission loss and turbulence effects.

For the passive system a further consideration was spectral bandwidth. A wide spectral bandwidth permits the collection of more signal; however, wide spectral bandwidth can result in potential dispersion errors due to the transmission through certain optical materials. The spectral range considered was Δλ=50 nm to Δλ=150 nm.
Passive 6 aperture system can operate with good signal to noise ratio out to 140 km
Active 3 aperture system can operate with good signal to noise ratio out to 140 km and provide night and day capability

When conducting imaging of targets on the ground over long ranges it is important to account for the average atmospheric transmission over the spectral bandwidth of interest. In order to accurately predict the transmission loss in proposed scenarios, simulation program, Modtran 5.3.2, was run with the conditions listed in Table 2:

TABLE 2
Modtran Parameters

| Sensor Height | 18.288 | km |
|---|---|---|
| Target Height | 0.01 | km |
| Range | 40, 100, & 150 | km |
| Model | Mid-latitude 45° N | |
| CO₂ Mixing Ratio | 390 | ppm |
| Rural Aerosol Model | 23 | km Visibility |

The specific scenario was for a system located at an elevation of 18 km imaging a target on the ground and run as a slant path between the two points. All cases were run as mid-latitude summer (45-degree north) and a table of the average atmospheric transmission over specified range and spectral bandwidth is given in Table 3.

In the passive imaging case, three spectral bandwidths were considered, 50 nm and 150 nm, and for the active illumination case the laser bandwidth was limited to 10 nm. This data is then utilized in the following sections for calculating the actual photon levels at the sensor and its associated signal to noise ratio values.

In order to accurately model an imaging system's expected performance, link budget calculations were performed for operational scenarios described in Table 2 and the range of parameters listed in Table 3.

TABLE 3
Link Budget Parameters

| Parameter | Value Limits | |
|---|---|---|
| Range to ground target | 40 km | 140 km |
| Elevation of platform | 18 km | |
| Atmospheric Turbulence Parameter | No Turbulence | HV57 |
| Atmospheric Transmission | Modtran Mid-latitude Summer | |
| Target Reflectivity Profile | 100% Signal Return | Target orientation normal to |
| | | 45 degrees off axis with |
| | | respect to receiver |

| | |
|---|---|
| System wavelength | Near IR (1.5 μm) |

The details of these two systems are presented below. For the link budget calculations the basic assumptions for each are presented in Table 4 &

Table 5.

TABLE 4
Passive System Parameters
Passive System Parameters

| | |
|---|---|
| Format | 1024 × 1024 |
| Pixel ifov (homodyne detection) | 1.3 μrad (3 apertures), |
| | 0.55 μrad (6 apertures) |
| QE | 0.85 |
| Dark Counts | 100 e⁻ per pixel per second |
| | (L-N2 cooled) |
| Read Noise | 30 e⁻ |
| Integration Time | 3 msec |
| ηrec (receiver transmission) | 0.75 |
| ρ into 2π (albedo of target) | 0.15 |
| Number of Apertures | 3 or 6 |
| Diameter of single collection aperture | 0.2 m |
| Effective total diameter (Dtot) | 3 apertures = 0.4 m |
| | 6 apertures = 0.73 m |
| Solar Flux | 0.23 W/m²-nm |
| Solar flux angle | 45-deg |

TABLE 5
Active System Parameters
Active System Parameters

| | |
|---|---|
| Format | 128 × 128 |
| Pixel ifov (homodyne detection, 3 apertures) | 1.9 μrad |
| QE | 0.3 |
| Dark Count Rate | 40 kHz |
| Integration Time for background | 500 nsec |
| ηtrans (transmitter transmission) | 0.75 |
| ηrec (receiver transmission) | 0.75 |
| ηpolar (polarization transmission) | 0.5 |
| Number of receive apertures | 3 |
| Laser Power | 40 W |
| Integration period | 128 Hz |
| Diameter of collection aperture | 0.2 m |
| Effective Dtot | 0.4 m |
| Target albedo (reflectivity) into pi radians | 0.2 |
| Solar flux angle for background calculation | 45-deg |

### Passive Link Budget

A passive link budget is calculated for the received signal from a solar illuminated source. Two spectral bandwidths are considered for both the three aperture and six aperture cases. While the six aperture case is intended to be passive only, the three aperture case will be utilized in both the passive only case and the active case which is discussed below.

The calculation for the number of passive photons at the collection aperture from a solar illuminated scene is given by the following equation:

$$Sig Passive Photons = \frac{{A}_{rec}}{{R}^{2}} * {θ}_{pix}^{2} * {R}^{2} * Δλ * SolarFlux * Δ t * \frac{λ}{hc} * {η}_{atm} * \frac{reflectivity}{2 π} * cos ( θ solar ) * {η}_{rec} * NumApertures$$

where, A_{rec} is the individual sub-aperture receiver area, R is the range, θₚᵢₓ is the yield of view of each pixel, Δλ is the bandwidth of the received signal, SolarFlux is a solar constant that depends upon the time of day and the value were taken from the American Society for Testing and Materials for a 37° sun facing a tilted surface with standard atmospheric conditions, Δt is the integration time, h is Planck's constant, c is the speed of light, reflectivity is the reflectivity of the target of interest, and η_{rec} is the refractive index of the receiver.

The signal to noise ratio for the passive signal is defined as

$$SNR = \frac{Sig Photons * QE}{\sqrt{Sig Photons * QE + DarkCounts + {ReadNoise}^{2}}}$$

As Table 3 shows, both the 3 and 6 aperture cases maintain an SNR above 3 for all ranges considered up to 140 km even for a 50 nm bandpass. A 50 nm spectral bandwidth is desired as it allows for a simpler and lower cost optical design and components. However, for longer ranges, and higher SNR signals, the spectral bandwidth can be increased and a more exotic optical material will be used to limit optical dispersion (as discussed further in the optical design section).

TABLE 6
Passive Imaging Photon Count and SNR
Passive Imaging SNR & Photon Count @ 1550 nm and
10 msec integration

| | | 3 Aperture Case | | | 6 Aperture Case | | |
|---|---|---|---|---|---|---|---|
| | | Target Range = | | | | | |
| Δλ | | 40 km | 100 km | 140 km | 40 km | 100 km | 140 km |
| 50 | Photons | 431 | 310 | 250 | 196 | 141 | 113 |
| 50 | SNR | 10.3 | 7.7 | 6.4 | 5.1 | 3.8 | 3.1 |
| 150 | Photons | 1155 | 703 | 505 | 524 | 319 | 229 |
| 150 | SNR | 22.6 | 15.4 | 11.8 | 12.1 | 7.9 | 5.9 |

The requirement of the detector array to meet the resolution requirements is to sample the scene at the Nyquist limit of the receiving aperture. For homodyne detection this results in the following equation:

$$\begin{matrix}ifov = \frac{1}{2} \frac{λ}{( 2 * {D}_{tot} - {D}_{rec} )} \\ = 1.3 \times {10}^{- 6} radians for 3 apertures \& \\ 0.55 \times {10}^{- 6} radians for 6 apertures\end{matrix}$$

In order to encode the unique spatial frequencies in the homodyne system, finer pixel sampling is required than typical Nyquist sampling. In addition, even though the 6 aperture case collects more light in total, each pixel samples a ˜4× (in area) smaller region and thus each pixel receives ˜2× less light.

The detector field-of-view for 1024 pixels is

$$\begin{matrix}Detector fov = ifov * NumPixels \\ = 1.3 mrad for 3 apertures and 0.62 mrad for 6 apertures\end{matrix}$$

TABLE 7
Passive Field-of-View
Field-of-view Parameters for Passive Detection
(1024 × 1024) & 3 apertures

| | 40 km | 100 km | 140 km |
|---|---|---|---|
| Pixel ifov at range (m) | 0.0.052 | 0.129 | 0.181 |
| Pixel ifov area at range (m²) | 0.0027 | 0.0167 | 0.0327 |
| Detector fov at range (m) | 52.9 | 132.3 | 185 |
| Detector fov area at range (m²) | 2799 | 17494 | 34289 |

### Active Link Budget

Active techniques permit operation at night providing a 24/7 capability and utilizing the fringe imaging technique increases the effective diameter of the receiving system yielding a 2× improved resolution over the passive three-aperture case. Simulations for the these embodiments have shown that 24.5 photo electrons per pixel—98 photo electrons per pixel are sufficient to achieve good quality reconstructions. This is equivalent to a signal to noise ratio of 5 to 9.9. This is the total number of photons per pixel over all 49 phase frames (7 transmit phase shifts×7 receive phase shifts). For a 40 W laser at 200 kHz, 32 non-saturated Geiger pulses are required to be summed for each transmit and receive phase shift. Therefore, seven transmit phases, seven receive phases, and 32 Geiger summations at a 200 kHz laser repetition rate yield an image every 128 Hz. In addition eight atmospheric realizations are needed for atmospheric dewarping, thus yielding a fully dewarped image at 16 Hz

128 Hz*32 repeats for SNR*7 transmitter phases*7 receiver phases=200 kHz

The active illumination link budget is used for imaging scenarios at night, when passive illumination is not available, and at closer ranges, when increased resolution of a target is required.

The calculation for the number of active photons at the collection aperture from a laser illuminated scene is given by the following:

$$Sig Active Photons = \frac{{A}_{rec}}{{R}^{2}} * {θ}_{pix}^{2} * {R}^{2} * \frac{LaserAvgPower}{prf * Abeam @ Target} * \frac{λ}{hc} * {η}_{trans} * {η}_{atm}^{2} * \frac{reflectivity}{π} * {η}_{rec} * {η}_{polar} * NumApertures$$

where prf is the pulse repetition frequency of the laser, ηₚₒₗₐᵣ the signal loss for polarization, ηₐₜₘ is the atmospheric transmission, ηₜᵣₐₙₛ is the optics transmission. The area of the laser illuminated area at the range of interest is fixed at 8 m×8 m (64 m²).

The signal to noise ratio is then calculated by:

$$SNR = \frac{Sig Photons * QE}{\sqrt{\begin{matrix}Sig Photons * QE + SolarBackgroundPhotons * \\ QE + DarkCountRate * Integration Time\end{matrix}}}$$

The SNR at various target ranges are shown in Table 8. In order to achieve the minimum SNR of 5 at the longest ranges of 140 km, more Geiger samples can be integrated or a higher power laser can be used. Simply integrating more pulses would lower the single atmosphere imaging rate from 128 to 100 Hz, or increase the required laser power from 40 W to 49 W.

TABLE 8
Active Photon Count and SNR
SNR and Photons

| | Target Range = | | |
|---|---|---|---|
| | 40 km | 100 km | 140 km |
| Laser Photons Collected | 168 | 96.9 | 67.2 |
| SNR | 7.1 | 5.4 | 4.5 |
| Time to process frames for one image | 7.8 msec | 7.8 msec | 7.8 msec |

It is necessary for the detector array to sample the scene at the Nyquist limit of the receiving aperture with three apertures and heterodyne detection to provide an instantaneous field of view (ifov) of:

$$ifov = \frac{1}{2} \frac{λ}{{D}_{tot}} = 1.9 \times {10}^{- 6} radians$$

with a detector field-of-view for 128 pixels of:

Detector ifov=ifov*NumPixels=0.25 mrad.

TABLE 9
FOV Parameters for Active Detection
Field-of-view Parameters for Active Detection

| | 40 km | 100 km | 140 km |
|---|---|---|---|
| Pixel Ifov at range (m) | 0.078 | 0.194 | 0.271 |
| Pixel Ifov area at range (m²) | 0.006 | 0.038 | 0.074 |
| Detector fov at range (m) | 9.92 | 25 | 35 |
| Detector fov area at range (m²) | 98 | 615 | 1205 |

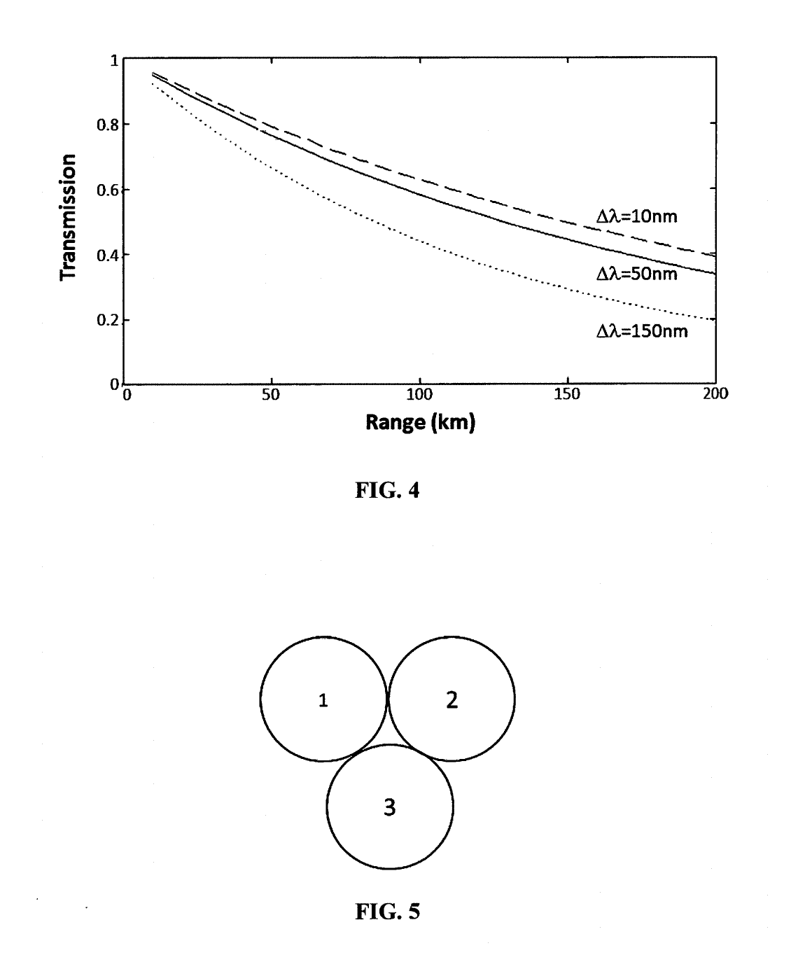

Since the field size on the ground is kept constant with range, the imaging approach is range insensitive and only range dependence comes from the atmospheric transmission. For the spectral bandpass considered in this specidication, the atmospheric transmission (averaged over the spectral bandpass) is shown in FIG. 4.

### Link Budget Conclusions

The fully passive link budget results show that photons collected at the receiver aperture from solar illumination are sufficient to image scenes passively out to 140 km using a spectral bandwidth of 50 nm. This is important since for a spectral bandwidth of 50 nm special dispersion correction is not required. The spectral bandwidth of 150 nm was included since the larger bandwidth provides more passive signal and there may be operational scenarios where more signal is required. If that is the case, dispersion correction will be required in the receiver telescope and a discussion of options is discussed below.

For active imaging a laser operating at 40 W and a pulse repetition frequency of 200 kHz is sufficient for imaging to 140 km for the conditions listed in Table 9. In addition, the 8×8 m (=16) field will be raster scanned in an 8×2 (=16) grid to achieve a 64×16 m full field of view.

### Image Processing Simulations and Algorithms

The algorithm section is broken down into the following categories. Section 1 will discuss the aperture synthesis reconstruction algorithm and how it works with respect to both the heterodyne and homodyne imaging systems. Section 2 goes into the mathematical details of the fringe imaging technique (FIT) algorithm and how it is able to trade receiver area for transmitter complexity and obtain a higher resolution image. Section 3 describes the proposed aperture arrays and how the different arrangements affect the final resolution by comparing the MTF of each one and conducting a basic Humvee imaging scenario. Section 4 delves into the expected resolution by conducting bar chart simulations for the different aperture designs when using the specified 20 cm sub-aperture. Section 5 combines full wave propagation, 3 transmitters, 3 receivers, and de-warping into a full simulation through turbulence with range gated data.
Demonstration of the aperture synthesis algorithm that compensates for aperture jitter,
Demonstration of the MTF correction enhancement algorithm,
Resolution verification using bar targets at 1550 nm for different ranges and aperture configurations using 20 cm sub-apertures,
Demonstration of the System with dewarping.

The aperture synthesis algorithm can be broken into 3 main sections as shown in FIG. 3. The first is to optimize the setup to extract the beat frequency terms of the entire aperture. This step is dependent on which system is being used; the homodyne system requires spatial term extraction from the single frame, while the heterodyne system requires temporal term extraction from multiple frames, where the number of frames is dependent on the number of sub-apertures in the system. Each beat term is defined as the complex wavefront of one aperture times the complex conjugate of the wavefront of the other. For the 3 aperture case, for both homodyne and heterodyne, this results in A₁A₂*, A₂A₃*, and A₃A₁* with the apertures defined in FIG. 5, with Aᵢ being defined as the complex wavefront of aperture i.

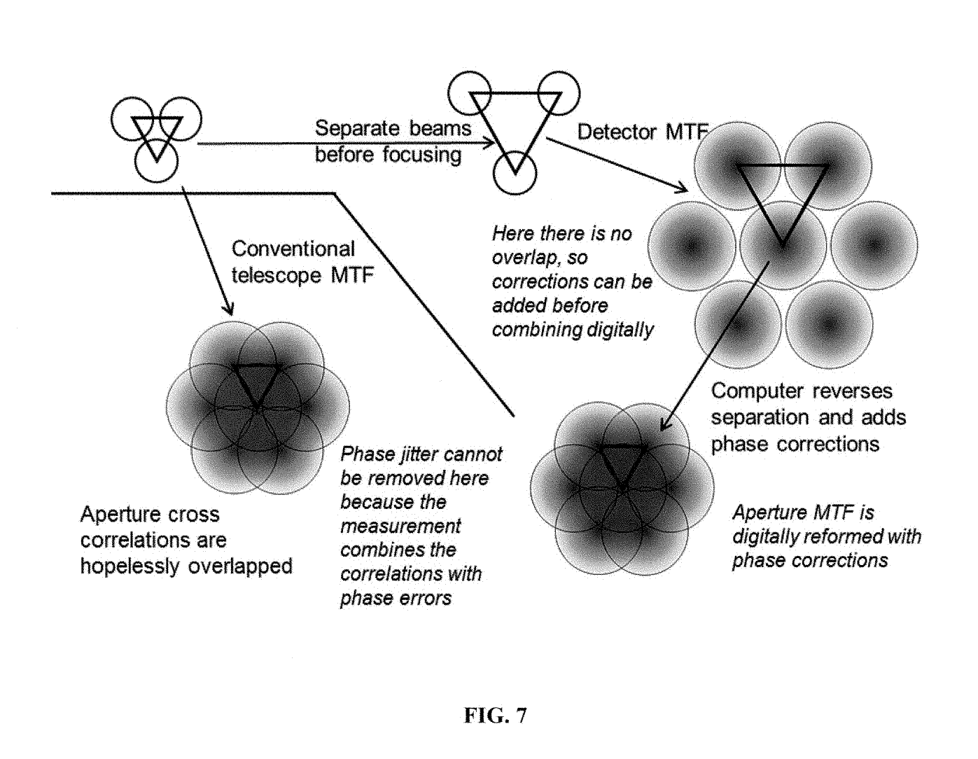

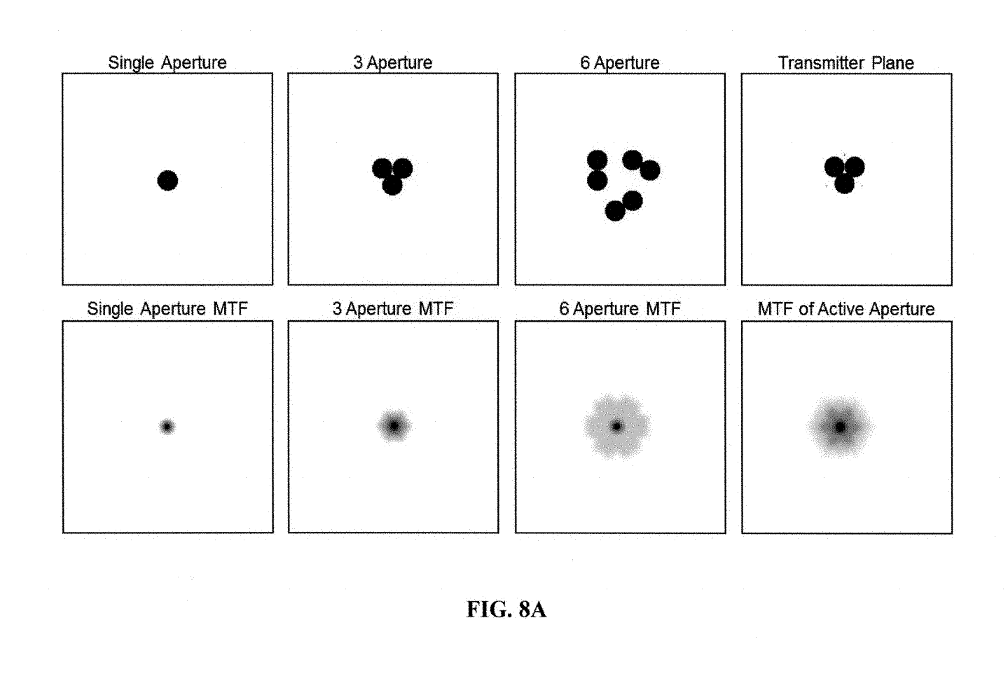

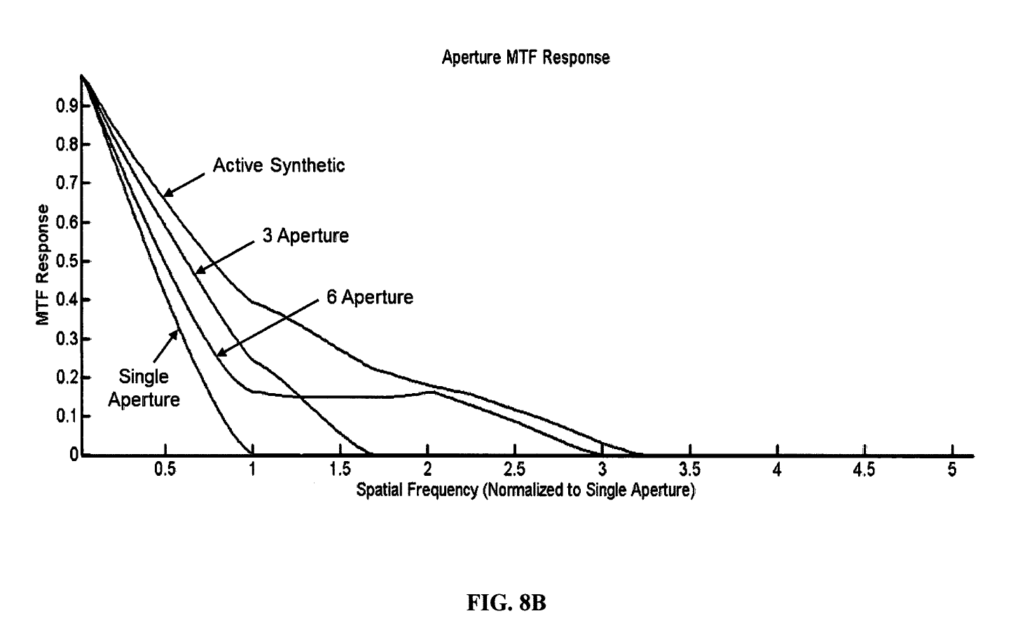

An example in FIG. 7 using the homodyne technique shows how the terms are related to the MTF of the system and why they need to be extracted. For the homodyne system two grating assemblies are used to separate the reflected light from the target tha is collected by the three apertures. The next step (data acquisition) after beat term extraction is to correct for the phase jitter component between each individual aperture, this is a common step between both implementation techniques and relies on phase matching common data in the Fourier U-V plane to maximize the intensity squared, <I²>. After this phase jitter has been corrected the final step (image processing) combines the corrected beat terms back into a single image. Depending upon the system, atmospheric corrections may also be applied. The physical apertures are shown in FIG. 8A.

### Mathematical Description of the Fringe Imaging Technique

The conventional diffraction limit of an aperture is valid for the case of on-axis imaging of a uniform illumination scene. However, when structured illumination is projected onto the scene, the effective resolution of the aperture can be improved significantly. This is due to the fact that the illumination pattern produces a Moiré effect and aliases the spatial frequencies of the scene that would lie outside the nominal aperture bandpass down into the system optical transfer function (OTF). Using an approach where the scene is illuminated with a number of different sinusoidal patterns well separated in Fourier space kₛ(u,v) and with each modulated at discrete temporal frequency, ω, allows one to separate out the un-aliased spectrum components from the aliased values which contain the higher spatial frequency information.

If we assume the target intensity profile is given by I(\vec{x}). Then, when a modulated intensity or fringe pattern is imposed on the target profile, the modified intensity profile is given by Equation 1:

$$I ( \vec{x} ) \cdot ( 1 + cos ( \vec{{k}_{S}} \cdot \vec{x} + ω \cdot t ) ) \qquad ( 1 )$$

Where kₛ is the spatial frequency of the modulated pattern applied to the target and ω is the temporal frequency of this pattern sweeping across the target. When the modulated target intensity profile is imaged through a telescope with a point-spread function PSF given by T(\vec{x}), then the resultant image is given the expression in Equation 2:

$$[ I ( \vec{x} ) \cdot ( 1 + cos ( \vec{{k}_{S}} \cdot \vec{x} + ω \cdot t ) ) ] ⊗ T ( \vec{x} ) \qquad ( 2 )$$

where the telescope blurring function is convolved with the modulated target pattern. If we look at these expressions in Fourier transform space, the transform of the left-hand side of the convolution expression can be rewritten as Equation 3:

$$I ( \vec{k} ) ⊗ ( δ ( \vec{k} ) + \frac{1}{2} \cdot δ ( \vec{k} - \vec{{k}_{S}} ) \cdot {e}^{- 1 i \cdot ω \cdot t} + \frac{1}{2} \cdot δ ( \vec{k} + \vec{{k}_{S}} ) \cdot {e}^{- 1 i \cdot ω \cdot t} ) \qquad ( 3 )$$

In this expression I(\vec{k}) is the Fourier transform of the target profile, and δ is a delta function in Fourier space. This can be understood by noting that when the modulated target pattern is Fourier transformed, the result is the convolution of the =modulated target profile with a delta function at the zero frequency beam (referred to as the DC point) and the two sidebands points located at the spatial frequency location of the modulated fringe pattern. The convolution with the delta functions can be simplified to the following expression as Equation 4:

$$I ( \vec{k} ) + \frac{1}{2} \cdot I ( \vec{k} - \vec{{k}_{S}} ) \cdot {e}^{- 1 i \cdot ω \cdot t} + \frac{1}{2} \cdot I ( \vec{k} + \vec{{k}_{S}} ) \cdot {e}^{1 i \cdot ω \cdot t} \qquad ( 4 )$$

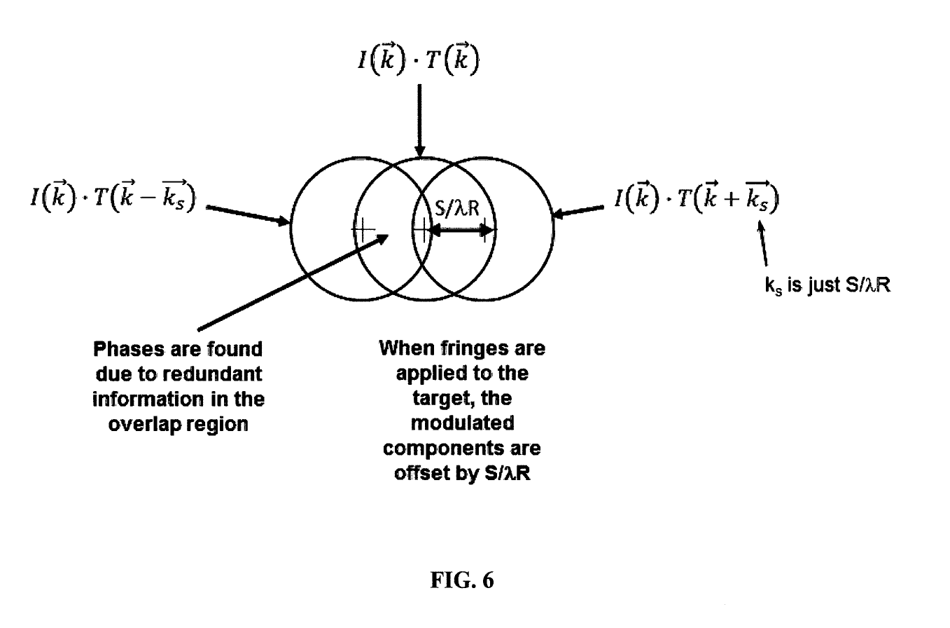

Looking again at Equation 4, the Fourier transform of the right-hand side of the expression is just the OTF of the imaging optical system T(\vec{k}). Thus, the transform of Equation 4 can be written as Equation 5

$$( I ( \vec{k} ) + \frac{1}{2} \cdot I ( \vec{k} - \vec{{k}_{S}} ) \cdot {e}^{- 1 i \cdot ω \cdot t} + \frac{1}{2} \cdot I ( \vec{k} + \vec{{k}_{S}} ) \cdot {e}^{1 i \cdot ω \cdot t} ) \cdot T ( \vec{k} ) \qquad ( 5 )$$

where the convolution operator is converted to multiplication in transform space. This expression can be seen as the sum of a DC term I(\vec{k})·T(\vec{k}) and two AC terms given by ½I(\vec{k}−\vec{k}ₛ)·T(\vec{k})·e^{iωt} and ½I(\vec{k}+\vec{k}ₛ)·T(\vec{k})·e^{iωt}. The DC term is simply what is obtained by imaging the target profile with a telescope that has an OTF function that is centered on the DC point in Fourier space. The AC terms, are products of target Fourier spectrum with the OTF function that has been shifted in frequency by ±kₛ. FIG. 6 shows graphically in the Fourier domain the expression in Equation 5. Thus, one can see that the fringe imaging implementation can measure spatial frequency components of the target beyond the typical diffraction-limited OTF of the telescope.

A reconstruction algorithm can then be used to place the aliased frequency information into the correct location in Fourier space resulting in an image with higher resolution. In addition, regions of overlap between the aliased and the un-aliased components can be used to match the overall global phase between the different OTF patches in Fourier space.

### Aperture Designs and MTF Response

During the course of this program four different aperture cases as shown in FIG. 8A were explored in detail in an effort to optimize system performance while minimizing SWaP for a practical system. Each of the different apertures explored has an associated MTF response that corresponds to spatial frequency components that the system is able to detect. Other aperture cases could be utilized. The more high spatial frequency components that the system is able to receive, results in a greater resolution of the final imaging system.

As can be seen in the FIG. 8A and FIG. 8B, the single sub-aperture case (far left in FIG. 8A) has the smallest MTF response and worst corresponding resolution, while the passive 6-aperture (tird from the left) and hybrid 3-aperture system are about equal. The 3-aperture case (second from the left) has double the resolution of the single aperture configuration and the 6-aperture passive and 3-aperture active configurations(far right) have a ˜3.25× better resolution than the single aperture case. A direct comparison between apertures were simulated by Applicants by using a general Humvee picture where the only change was the selected aperture configuration.

### Resolution

Applicant's simulation program contains a computer generated image of a Humvee that the simulation program can use to calculate an image of the Humvee with a variety of optical systems. In the Humvee examples each aperture array can be compared using the Humvee target to illustrate the differences between apertures, while showing that the apertures that contain more high spatial frequency components will achieve a greater resolution.

In addition to showing that the expected resolution is better, Applicants take the next step and show that by knowing what the aperture is, it is possible to compensate for low MTF regions of the aperture and further increase the resolution of the final image. The two different types of MTF-post processing have been demonstrated are with a conjugate gradient solver and by employing a positivity reconstruction technique which utilizes the known fact that intensity values should never be negative.

### Night Time Three Aperture Fringe Imaging Technique

The three aperture fringe imaging technique uses three different transmitters to increase the spatial frequency response of the received image with full mathematical details being presented above in the algorithm section. One of the obvious downsides to this imaging technique is that the higher resolution images are limited to the illumination profile that falls on the target.

### Daytime Three-Aperture FIT Technique

During the daytime the additional laser can be used to obtain a higher resolution at the center of the image where the laser is broadcasting, and fill in blank areas with passive signal.

### Resolution Verification

Applicants' simulations demonstrated, using an arbitrary computer simulated Humvee image, that the expected resolution is affected by the aperture array that was selected. As expected, the larger diameters resulted in a better final image due to the increased higher spatial frequencies.

Applicants used resolution bar targets to demonstrate what the expected resolution of each aperture array verifies that the developed models are accurate and match the expected theory. Simulation results prepared for the aperture cases at ranges of 40, 100, and 140 kilometers.

### Bar Chart Images

Applicants used US Air Force resolution bar chart images comparing simulation images of a single aperture camera with images of the same simulated target utilizing multi-aperture designs based on the present invention.

### Single Sub-Aperture:

For a single sub-aperture, at 40 and 100 kilometers, the bar chart displayed the bar target with size of λR/D, and after applying positivity the contrast for the smallest bars is improved.

### 3 Aperture Case:

In the three aperture case the resolution is improved by 2× from that of the single aperture system. The expected resolutions at 40 km, 100 km, and 140 km are 0.144 m, 0.360 m, and 0.504 m respectively.

### 6 Aperture Case:

In the six aperture case the initially recovered image deviates significantly from the ideal diameter as is observed in FIG. 36 but this deviation goes away after applying the positivity MTF correction. In all cases the expected resolution of 0.075 m, 0.188 m, and 0.263 m were achieved.

### Simulation with De-Warping

A simulation of Applicants' de-warping technique was performed at range through simulated turbulence. The parameters are as follows:
1. Turbulence level HV5/7
2. Wavelength 1550 nm
3. Altitude 14 km
4. Range to target 100 km

The simulations used full wave propagation through 10 phase screens. The grid pixel for all of the propagations was 1 cm. The grid sizes and boundary filtering settings of the propagation were rigorously computed to make sure there was no significant aliasing or loss of spatial frequency components.

Incoherent computations are much more computationally burdensome than coherent computations. To achieve incoherence, the transmitter beams and point spread function (PSF) for each pixel was separately computed. Then each pixel measurement is computed individually by multiplying the pixel's intensity PSF, the transmitter pattern intensity, and target retro-reflectance, and summing over all of the grid points. This computation is repeated for each depth slice of the image, each of the 7 transmitter phases, each of 7 receiver aperture phase settings, and each atmospheric realization. The atmosphere is approximated to be frozen during a single measurement realization, and then completely different for the next realization.

The computed images in patches of 16×16 pixels, at detector spacing corresponding to Q=2 for an individual aperture but Q=1 for the combined phased aperture. The Q=1 measurements are not individually Nyquist limited, but the use of 7 receiver phase measurements is done to disambiguate the Fourier components. Poisson noise is added to the measurements at a nominal level. The sensor geometry is shown in FIG. 2 for the heterodyne case. There are three 20 cm receiver apertures, separated by 24 cm. The three transmitter apertures are 19 cm from the center, with 33 cm separation.

The reconstruction algorithm used was modified to accommodate the multiple phased receiver measurements. The fringe imaging processing combines all of the projected spot measurements created by shifting the transmitter phases. The modification also combines the various receiver phase settings. The turbulence processing techniques of the present invention combines multiple atmospherically distorted images to produce a better quality images explained below:

### Active-Only Reconstruction

The first reconstruction of the data uses only the active laser component of the measurements.

This reconstruction uses a modified version of Applicants' algorithm to incorporate multiple aperture relative phase measurements. The range resolved data is useful in the de-warping process, as it is easy to ‘lock on’ to.

The above reconstruction used 8 photoelectrons per (10 realization) per (7 transmit phases) per (7 receive phases), but in a pixel which is Nyquist limited for a single sub-aperture. Thus, the total detector pixel size is λ/2D_{sub}, with 3900 pe⁻ per pixel detected over the entire measurement set. This is equivalent to ˜1000 photoelectrons per pixel in a full diameter pixel, or ˜250 photo electrons per pixel in a homodyne over-sampled pixel.

Applicants also reconstructed the same object at one-fourth of the above signal levels for comparisons. The results appear to have good de-warping, but naturally more shot noise.

### Refinements to the Conformal Multi-Aperture Optical Telescope Design

Two different cases were evaluated in order to provide a large field-of-regard for a system of several small apertures. The first involved the use of Risley prisms. Risley prisms are capable of supporting conformal optical systems; the downside is that at 1550 nm the use of silicon optics would require dispersion correction. This is discussed below in the dispersion error section. The other option is to make use of other exotic materials with less dispersion, e.g. ZnSe or ZnS. These materials, if required, would increase the optical system cost. Preliminary results presented below indicate that the use of silicon optics is appropriate.

Another approach that was considered involved individual fast steering optics. While this system can be made conformal, limitations of the field-of-regard made this choice less attractive.

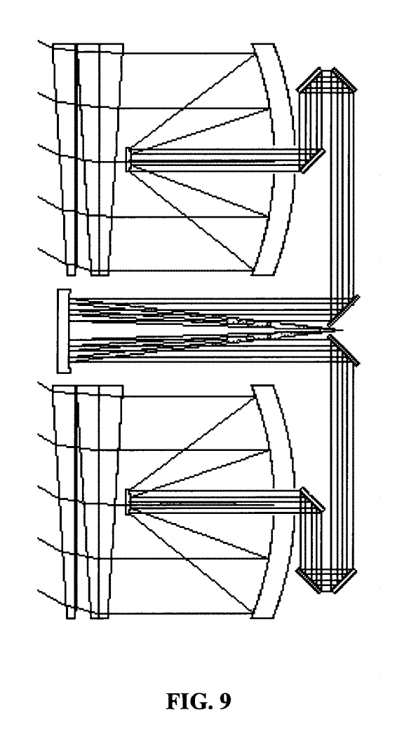

In the work presented the baseline approach will take advantage of Risley prisms limiting the spectral bandwidth to 50 nm and taking advantage of Si optics as shown in FIG. 9. The coherent combination of the apertures is still a requirement and will require trombone leg path matching.

In the section below the tolerances of wideband phasing of apertures is discussed. The Risley beam steering concepts can provide excellent performance over a 30 degree radial field-of-view (+/−15-deg). The design was analyzed in Zemax and the optical path difference was plotted indicating that there is essentially zero aberration over the 200 mm aperture.

### Tolerances for Wideband Aperture Phasing

A potential concern for large aperture wide bandwidth Risley prisms is wavelength dispersion. For coherent multi-aperture imaging this is even a larger problem due to the need to path match the individual aperture in order to coherently add the signals. This specification addresses the tolerance for aperture phasing over a specified bandwidth, and addresses the Risley dispersion.

### Phasing Without Error

The phase associated with a beam displacement of Δx is

ϕ=k₁₉₅Δx

where k_{⊥} is the transverse wave number of the beam.

It is assumed that the angles are small and can be approximated to first order which yields,

k_{⊥}≈k₀θ,

where θ is the angle of the ray being considered and k₀=2π/λ.

Since the displacement will typically occur after demagnification, the angle is then approximately proportional to the optical system magnification

θ≈θ₀M,

with θ₀ the system's field angle and M the magnification.

ϕ=k_{⊥}Δx=k₀θ₀MΔx

Displacements which are introduced dispersively, that is, Δx∝λ, result in a constant phase since Δk₀=2π, and the other terms have no wavelength dependence. This is why the system requires dispersive beam displacement for the spatial frequency offsets where each Risley beam is offset by a spatial frequency on the image sensor. This allows the separation of the various Risley-Risley beat components uniquely. Since they are already separated, it is possible to correct phase errors and even small pointing errors. The spatial frequency offsets are digitally removed to construct the final image, after the phase correction is applied.

To introduce a spatial frequency offset in a Risley prism, both color and bandwidth need to be taken into account. The spatial frequency added is given by

$$freq = \frac{offset}{λ \times folcal length}$$

Since the input is somewhat spectrally broadband, it is desirable to have the (offset) proportional to λ.

There are two potential ways to introduce the diffractive beam displacement of the individual apertures with an offset that is proportional to wavelength:
The first is to use one grating to introduce an angle, and another identical grating to remove the angle after a specified propagation distance. The diffraction angle is proportional to lambda, so the displacement is proportional to wavelength.
The second is to focus the beam onto a grating. An incident beam after hitting the grating will pick up spatial frequency. The beam is then re-collimated, and has an offset proportional to lambda.

### Error Terms

Two sources of error which must be considered are:
1. Positioning errors caused by path matching in the trombones, with no variable relay
2. Angular errors over wavelength caused by dispersion

### Trombone Path Matching

The pupil matching displacement can be expressed in terms of an axial distance

Δx_{L}=θL,

where L is the propagation distance which caused the transverse displacement.

After combining the final displacement is

ϕ=k_{⊥}Δx=k₀θ₀MΔx_{L}=k₀θ₀²M²L

At a single wavelength this phase shift is a constant and can be removed by the phase recovery algorithm. If there is a bandwidth, the varying phase shift causes a loss of contrast, however:

$$Δφ = Δ {k}_{0} {θ}_{0}^{2} {M}^{2} L \approx \frac{2 {πθ}_{0}^{2} {M}^{2} L}{λ} \frac{Δλ}{λ}$$

A requirement for good contrast is Δϕ<π/2, which generates the requirement on pupil matching be

$$L < \frac{λ}{4 {θ}_{0}^{2} {M}^{2}} {( \frac{Δλ}{λ} )}^{- 1}$$

For typical values λ=1.5 μm, M=10, Δλ/λ=3.2%, and θ₀=500 μrad, we have

L<469 mm

Corresponding to Δx_{L}<2.3 mm.

The amount of trombone travel will be of order Dθₘₐₓ, where D˜75 cm is the maximum aperture spacing and θₘₐₓ˜0.5 rad is the maximum field angle. This product would require 75 cm*0.5 rad=375 mm of relative travel, which is less than the above spec so there would no need for a variably reimaging trombone.

### Dispersion Errors

As mentioned above, one option would involve taking advantage of a material like ZnS with relatively low dispersion at 1550 nm. The current design does not necessitate this but it is included in the analysis below for completeness. The two materials under consideration in this analysis for the Risley prisms are Si and ZnS. Both simple prisms of this material, and alternatively diffractively corrected prisms in which a diffraction grating is included with each prism to correct the first order dispersion, leaving a still significant second order effect. Doublet-style two-material dispersion correction is clearly too bulky for this particular application.

If the example band of 1.3 μm to 1.5 μm is considered, the linear component dispersions are

$$\frac{{n}_{Si} ( 1.3 μ m ) - {n}_{Si} ( 1.5 μ m )}{{n}_{si} ( 1.4 μ m )} = 6.68 * {10}^{- 3}$$

$$\frac{{n}_{ZnS} ( 1.3 μ m ) - {n}_{ZnS} ( 1.5 μ m )}{{n}_{ZnS} ( 1.4 μ m )} = 1.59 * {10}^{- 3}$$

Notice that if the full field θₘₐₓ=0.5 rad, then the pointing dispersion is

Δθ_{Si}=3300μrad

Δθ_{ZnS}=800μrad

From the above discussion, it appears that handling dispersion generated by uncorrected Si Risley prisms would require an exceptionally wide field of view optical system, which is difficult but not impossible. The ZnS generated linear dispersion is more manageable. In both these cases, smaller bandwidth would ease requirements.

As a second option, consider prisms which are corrected to first order by a diffractive element. In this case the effective index is n_{Si}(λ)—C/λ where C is picked to compensate for the first order effect. In this case the compensated dispersion error is 1.75×10⁻⁴ for Si, and 3.26×10⁻⁵ for ZnS. Both of these options result in much smaller dispersion angles, which need correction, but can easily be accommodated by the telescope.

Two workable alternatives are as follows,
1. Silicon prisms with diffractive correction: Si prisms are easy to fabricate, but the diffraction element is highly nonstandard, and a source of loss and optical errors.
2. ZnS or ZnS) prisms, corrected after the reducing telescope: conceptually simple, but both of these materials are very expensive.
   and the bad alternatives,
1. Multiple refractive component prisms are too bulky.
2. Silicon with no diffractive correction leaves too large of a dispersion angle thorough the reducing telescope.
3. Correction only in the large Risley prisms, with no further correction after demagnification, is probably not a viable option unless system bandwidth is made much smaller.

The residual dispersion must be corrected to within typically 0.1λ/d where d is the subaperture diameter. This is accomplished by some yet-to-be-defined complicated but small optical element. This element would probably be a small Risley with null pointing angle, but controllable dispersion correction.

The second order effect is the displacement that occurs in the propagation to the correction element. Since the pointing error through the telescope is by design limited to very small angles with values of the order θ₀, the final system constraint is of similar magnitude as the trombone path match errors. This means that dispersion correction needs to be within ˜100 mm of a pupil which is very feasible.

### Preliminary Passive Hardware Validation

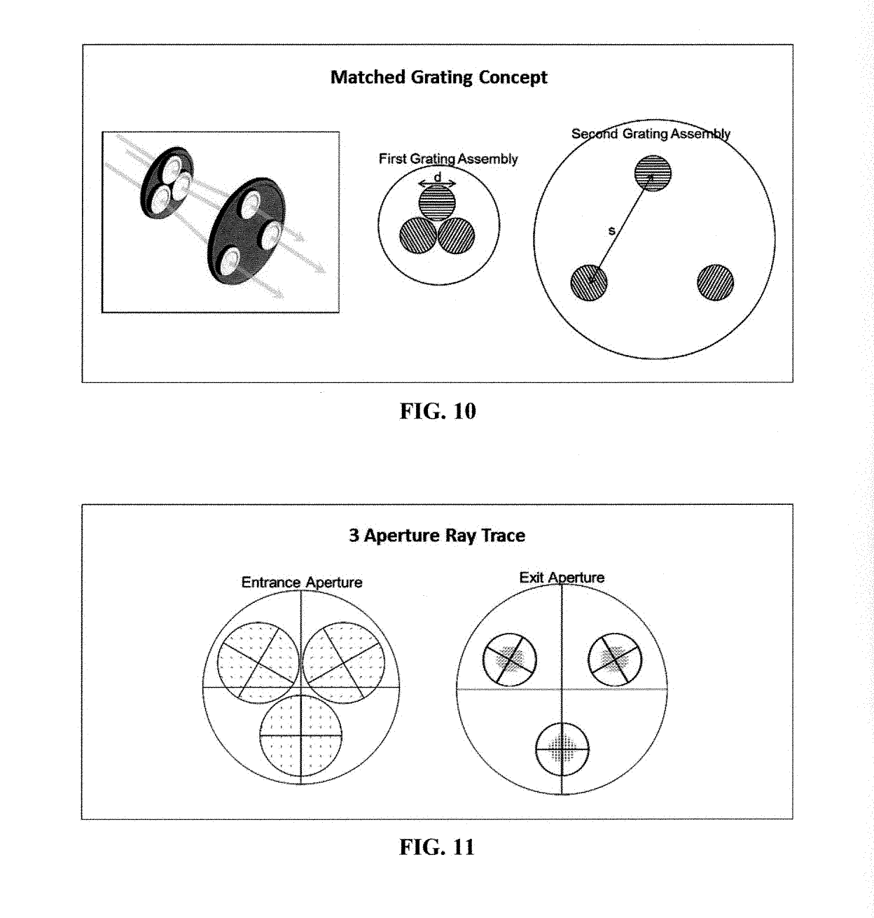

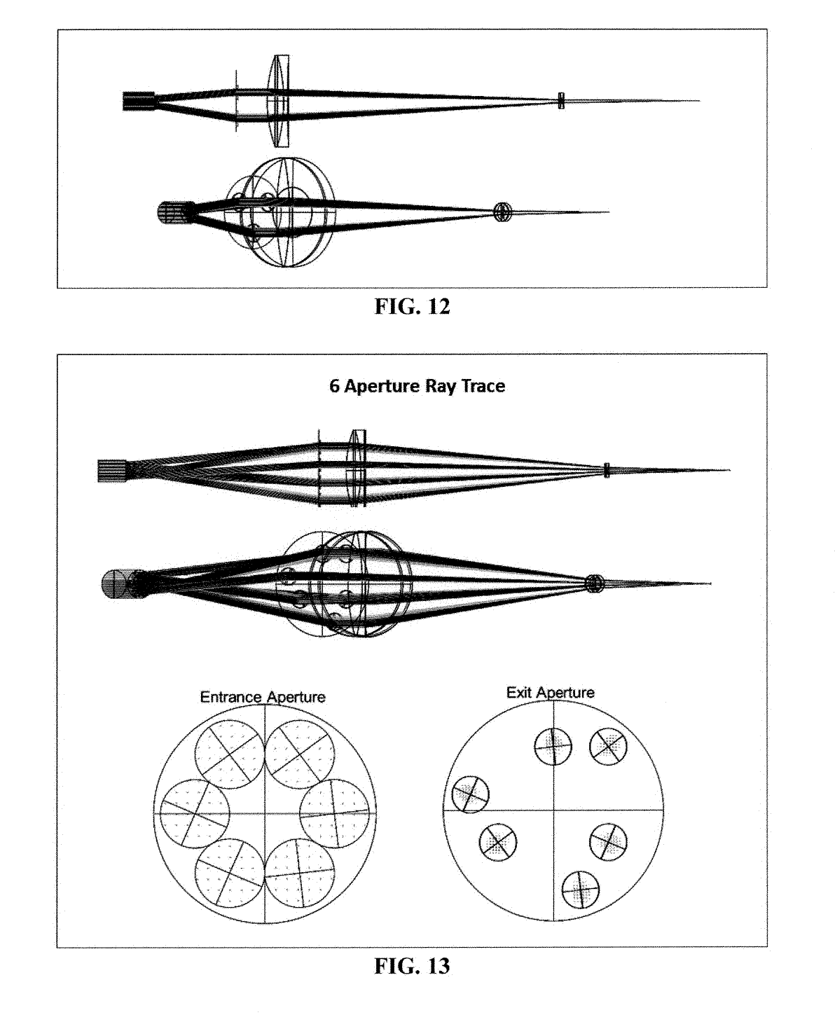

Applicants have constructed hardware that has 3 aperture and 6 aperture homodyne systems. The hardware includes a matched grating concept to separate the beams. A first set of gratings separates the wave fronts of the three sub-apertures that are then collimated using a 2^{nd} set of matched gratings. This concept is illustrated in FIG. 10. FIGS. 11 and 12 illustrate the optical ray tracing that was completed in Zemax for the 3-aperture design and FIG. 13 illustrates the 6-aperture designs. The 3-aperture design has a grating separation of 133 mm and an overall package length of 820 mm. The 3-aperture validation hardware had input apertures of one-half inch with a clear aperture for each grating of 10.95 mm and an overall diameter of 27.5 mm. Each exit aperture is 1 inch in diameter with a distance between gratings of 50 mm that requires a 4-inch diameter imaging lens to focus the light onto the detector. The 6-aperture validation hardware had input apertures of one-half inch with a clear aperture for each grating of 10.95 mm and an overall diameter of 39 mm. Each exit aperture is 1-inch diameter and arranged in a non-redundant array with the minimum distance between gratings being 37.5 mm and the maximum distance being 99.2 mm and requires a 6-inch diameter imaging lens to focus the light onto the detector.

The gratings are very sensitive and require matching the rotation angle between grating pairs to be within a tolerance of 0.02 degrees with a mean groove spacing of 0.03%. The sub-aperture alignment for the tip and tilt must be within 0.3 degrees, while the z dimension must be matched to within 0.5 mm. For the proof of concept demonstration of the aperture synthesis aperture phasing technique, targets were printed out on 18-inch×18-inch paper and mounted on target stands that were 130 meters away.

Outdoor data was taken with the preliminary hardware for both the 3-aperture and 6-aperture configurations to validate the design in the real world. The results demonstrate that the combined aperture synthesis technique provides a significant increase in the imaging system's resolution when compared to the single aperture system as well as the uncorrected version where the apertures are out of phase with each other.

### Next Generation Hardware

In future embodiments of the homodyne systems the individual gratings and their cumbersome alignment mounts and will be replaced by two diffractive optical elements (DOEs) that have the gratings etched into them in their desired locations. This will remove the a portion of the alignment tolerance since the sub-aperture gratings themselves will be etched with sub-wavelength accuracy to each other that will remove the mechanical alignment of each grating within their respective pupil planes. The only alignment that needs to occur then will be aligning the two large diffraction optical elements to each other which can be easily done with common opto-mechanical alignment techniques.

The other advantage to removing the individual gratings and their mechanical alignment is that it allows an increase in the clear aperture areas which will increase the signal to noise resolution of the overall system, due to more photons being collected, while also allowing more sub-apertures to be placed within the sub-aperture system which will result in a final image improvement due to increased beat term sampling. The other obvious result of moving to two matched diffraction optical elements instead of individual gratings is that the size and weight can be decreased significantly due to the reduced materials required.

### Hardware Conclusions

It was determined as a result of this analysis that a re-imaging trombone was not required due to the smaller beam size. For example, a 10× magnification would produce +/−2.5 mm of beam walk over the 1 mrad field-of-view resulting in a 20 mm beam diameter after the telescope. A 20× magnification would produce a +/−1.25 mm beam walk over the 1 mrad field-of-view resulting in a beam diameter after the telescope of 40 mm. Neither magnification would require re-imaging since the beam walk is small and does not introduce aberrations or significantly increase system size. Optimal telescope magnification will need to be determined based on final optical configuration of the integration and imaging optics behind the telescope.

With the Risley beam steering concept, as noted above the spectral bandwidth is an important consideration of the optical design. The results presented in Table 6 above show that a spectral bandwidth consistent with using silicon optics for the Risley prisms (Δλ=50 nm) still allows for an adequate number of photons, however, the selection of the detector will be important.

### Variations

Readers should recognize that the examples described above of preferred embodiments are merely examples of embodiments of the present invention and that many other variations and additions could be made within the scope of the invention.

For example additional hardware or design work could be added to increase the density of the sub aperture count per image. This can be done by adding additional apertures to produce additional beams that can carry information of the target to the detectors. Preferably, efforts should be made to assure that the propagation lengths are kept the same for ease of image reconstruction.

This same technique could also be adapted to shorter ranges since the technique itself is range agnostic.

Various techniques are available for pointing to the heterodyne and homodyne beams toward targets including use of Risley prisms. Gimbals could also be used for beam pointing. Several well-known tracking techniques other than those described above could be utilized. The systems could be positioned at many locations on the aircraft other than the location shown in FIG. 1.

For all of the above reasons the scope of the present invention should be determined by the appended claims.

What is claimed is:

1. A high resolution multi-aperture aircraft imaging system for imaging targets at ranges in excess of 50 km comprising:
A. at least three apertures for collecting light reflected from the target,
B. an optical sensor having a pixel array for converting light intensity into electrical signals at each pixel of the pixel array,
C. focusing components for focusing the light from the at least three apertures onto three separate non-overlapping positions of the optical array,
D. optical beat extraction components for extracting beat signals from the electrical signals,
E. computer processor components programmed with at least one algorithm to process the beat signals to:
1) correct for phase distortion in each of the at least three signals,
2) correct for jitter in each of the at least three signals,
3) de-convolve the jitter corrected signal, and
4) re-combine the beat signal data from the at least three separate apertures in order to produce an image of the target.

2. The imaging system as in claim 1 wherein the imaging system is adapted to utilize a hetrodyne aperture reconstruction technique.

3. The imaging system as in claim 1 wherein the imaging system is adapted to utilize a homodyne aperture reconstruction technique.

4. The imaging system as in claim 3 wherein the beat signals are spatially separated beat terms.

5. The imaging system as in claim 4 wherein a phase tilt solver is utilized to correct the phase distortion.

6. The imaging system as in claim 5 wherein the jitter is corrected with a jitter correction algorithm to produce a jitter corrected signal

7. The imaging system as in claim 6 wherein the estimated power and noise spectrum is utilized to de-convolve the jitter corrected signal.

8. The imaging system as in claim 1 wherein a block matching algorithm is utilized to sense turbulence induced localized shifts in images and to perform correction of the images.

9. The system as in claim 2 wherein the system comprises three transmitters and three receivers.

10. The system as in claim 2 wherein the system utilizes Risley prisms for beam pointing.

11. The system as in claim 10 wherein the Risley prisms are silicon prisms.

12. The system as in claim 10 wherein the Risley prisms are Zn or ZnS prisms.
